(19) United States
(12) Patent Application Publication
(10) Pub. No.: US 2008/0259033 A1
(43) Pub. Date: Oct. 23, 2008

(54) BOOK-NOTEPAD PERSONAL COMPUTING DEVICE

(76) Inventor: Songchun Mu, (US)

Correspondence Address: SONGCHUN MU, 46817 NORTHBROOK WAY, STERLING, VA, 20164, US

(21) Appl. No.: 12/101,113

(22) Filed: Apr. 10, 2008

Related U.S. Application Data
(60) Provisional application No. 60/912,701, filed on Apr. 19, 2007.

(51) Int. Cl. G06F 3/033

(52) U.S. Cl. 345/163; 345/156

(57) ABSTRACT

Using stylus-mouse combo pen input device replacing conventional keyboard and mouse on personal computing device, the book-notepad personal computing device decreases the size and weight of personal computing device provides more user friendly nature input interface for personal computing devices. This invention can be widely used for portable personal computing devices and encourage the nature handwriting skills for human beings.

### CROSS-REFERENCE TO RELATED APPLICATIONS

This application claims the benefit of provisional patent application No. 60912701 filed Apr. 17, 2007 by the present inventor.

### FEDERALLY SUPPORTED RESEARCH

None

### SEQUENCE LISTING OR PROGRAM

None

### BACKGROUND

1. Field of Invention

This invention relates to portable personal computing device.

2. Prior Art

Current portable personal computing device mainly has two major parts: 1. a main body which consists of electronic components with input devices including keyboard and mouse; 2. a liquid crystal display screen attached to the main body. Since keyboard is the major conventional input device and it makes the portable personal computing device doubled in size. The conventional portable personal computing devices have following drawbacks.

A. for foldable or sliding keyboard increases the thickness of a portable computing device when the keyboard and main body of the device in folding position; the folded keyboard and main body of the computing device together increase the total size of the device when users open the device and start using the device.

B. for a portable personal computing device with small keyboard beside or under the display screen increases the size of the device and inconvenient for users to typing due to the small key size.

C. for a touch screen portable personal computing device, such as booklet PC, the touch screen increases the device cost, decreases the screen life and the screen could not be protected directly by any hard cover.

### SUMMARY

This invention uses a stylus-mouse combo pen (FIG. 2) to replace the built in keyboard and mouse so that it reduces the size of portable personal computing device. By using the stylus-mouse combo pen as a input device for portable personal computing device, the book-notepad personal computing device can be made the same size as convention paper book or notepad and more convenient for users. Since the combo pen input works the same way as conventional pen or pencil, this invention also improves people's nature handwriting skills as opposed to typing.

### DRAWINGS—FIGURES

FIG. 1 is the main body of the book-notepad personal computing device with input windows

FIG. 2 is the input device, stylus-mouse combo pen

### REFERENCE NUMBERS

101 book-notepad personal computing device main body
102 liquid crystal display screen
103 function buttons
104 input window
105 mouse pad
201 dual function pen-point (mouse mode or stylus mode)
202 mouse right button
203 input combo pen body
204 mouse left button
205 mouse wheel switch (mouse wheel mode or capital letter mode)
206 function switch (mouse mode or stylus mode)
207 on/off switch

### DETAILED DESCRIPTION

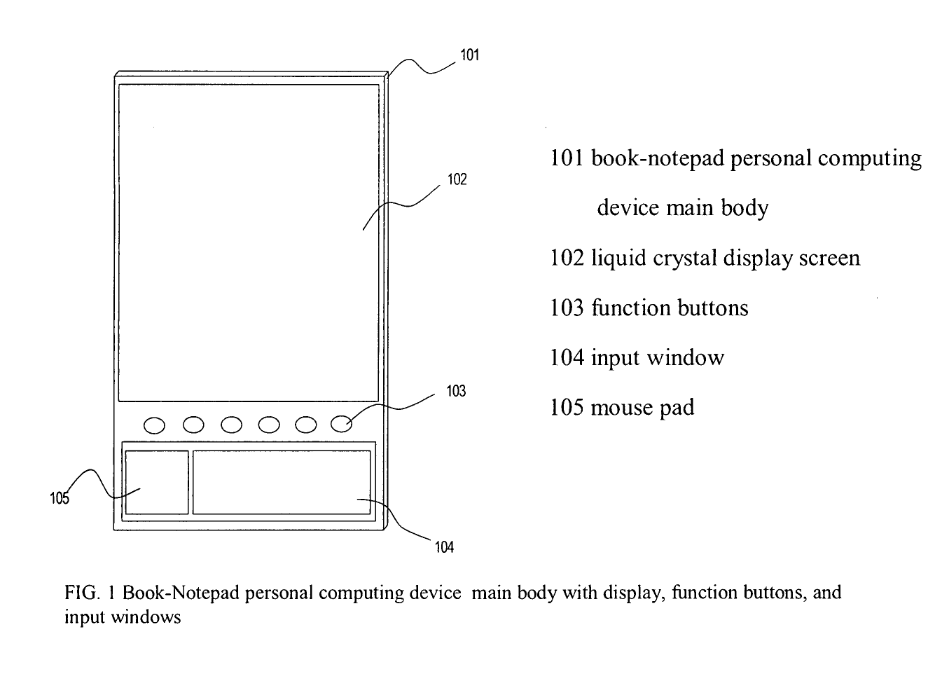

### First Embodiment—FIG. 1

FIG. 1 is the first perspective view constructed in accordance with the invention, the main body of the book-notepad personal computing device.

### Operation—First Embodiment—FIG. 1

The main body 101 of the book-notepad personal computing device has multiple functions. After the on/off power switch, one of the function buttons 103 is tuned to on position, electronic book function been enabled, and a book been chosen, the book cover page will be displayed on a liquid crystal display screen 102; the page up/down button included in function buttons 103 and the stylus-mouse combo pen (Gig. 2) is used alternatively to control the page display. When the notepad function has been enabled and the picture/text input button on text input mode, a user can use the stylus-mouse combo pen to write handwriting style text on to the stylus input window 104. A built-in customizable intelligent character recognition program will convert the input to standard machine-editable text as desired or keep it in handwriting format controlled by one of the function buttons 103. The mouse pad window 105 is used for receive mouse signal as a mouse input interface. When none of electronic book and notepad functions are enabled, the book-notepad computing device is acting as regular personal computer controlled by a operating system. In the computer mode, the stylus-combo pen is alternatively used in mouse mode and stylus mode according to a application requirements.

All the conventional portable personal computing device components is installed in the inside of the main body 101 the same way as conventional portable computing devices. These components include motherboard, central processing unit, memory, video card, cooling fun, and so on.

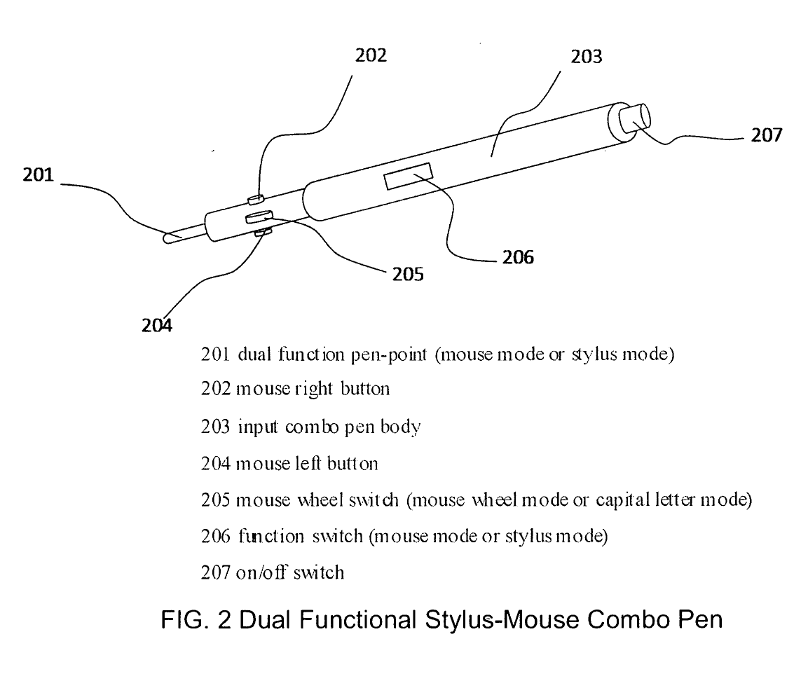

### Detailed Description—Second Embodiment—FIG. 2

FIG. 2 is the second perspective view constructed in accordance with the invention, an input device, the stylus-mouse combo pen for the book-notepad personal computing device.

### Operation—Second Embodiment—FIG. 2

The stylus-mouse combo pen (FIG. 2) has both stylus and mouse functions. It is controlled by an on/off power switch 207 and a stylus/mouse function switch 206 on the combo pen body 203. When the power switch 207 is in on position (button been pressed in), by default, the combo pen is in mouse mode. A user can use the pen to move the mouse curser by touching the mouse pad window with the dual-functional pen-point 201 of the combo pen. The left button 204, right button 202, and mouse wheel switch 205 are the same function as the buttons and wheel in regular personal computing device mouse. When the switch turns to stylus mode, a user can use it as an input pen by writing regular handwriting cursive letters or personalized cursive letters on to the input window 104 of the book-notepad personal computing device. The mouse wheel switch 205 can be used to switch to capital or lower case letter input under stylus mode.

### CONCLUSION

A book-notepad personal computing device by using stylus-mouse combo pen to replacing conventional keyboard and mouse input device in personal computing devices, it decreases the size and weight of the conventional portable computing device; it can be widely used in classroom as electronic book, notebook, and a computing device as well. The stylus-mouse combo pen input method is more user friendly and provide more nature way to interactive with a electronic computing devices.

I claim:

1. A book-notepad personal computing device for users to store and read electronic books, to writ electronic note, compose other electronic files, and accomplish other computing tasks using conventional handwriting input on a personal computing device, comprising;
a. means for electronic book and notepad page store and display; and
b. conventional handwriting input.

2. The book-notepad personal computing device in accordance with claim 1, wherein said means for storing and displaying electronic books and notepad pages comprises book-notepad pc main body with no touch screen liquid crystal display and keyboard.

3. The book-notepad personal computing device in accordance with claim 1, wherein said means for using conventional handwriting input comprises a stylus-mouse combo pen.

4. A dual functional computer input device, wherein said means for having both electronic handwriting pen and computer mouse functions.
